(19) United States
(12) Patent Application Publication
(10) Pub. No.: US 2008/0153356 A1
(43) Pub. Date: Jun. 26, 2008

(54) Electric Connector Provided with a Reversible Cap for Guiding a Cables and Method for Assembling Said Connector

(76) Inventor: Frederic Chazottes, Epernon (FR)

Correspondence Address: HARRINGTON & SMITH, PC, 4 RESEARCH DRIVE, SHELTON, CT, 06484-6212, US

(21) Appl. No.: 11/795,630

(22) PCT Filed: Jan. 18, 2006
(86) PCT No.: PCT/EP06/00409

§ 371 Date: Jul. 19, 2007

(30) Foreign Application Priority Data
Jan. 21, 2005 (FR) 05 00679

(51) Int. Cl. H01R 24/00

(52) U.S. Cl. 439/626

(57) ABSTRACT

This electric connector including an insulating casing furnished with cavities for receiving respective contacts connected to cables; a cap, which forms a guide for the cables and is arranged and fixed onto the casing; an operating element, which is movably mounted on the assembly formed by the casing and the cap and is intended for interactive engagement with a complementary element disposed on the matching part for the connector in order to ensure the coupling or the decoupling of the connector and its matching part. The operating element is movably mounted on the cap. The invention also relates to a method for assembling said connector.

The invention relates to an electric connector comprising:
an insulating casing furnished with cavities for receiving respective contacts connected to cables;
a cap that forms a guide for the cables and is arranged and fixed onto the casing; and
an operating element that is movably mounted on the assembly formed by the casing and the cap and is provided for interactive engagement with a complementary element disposed on the matching part for the connector in order to ensure the coupling or the decoupling of the connector and its matching part.

In certain known connectors of this type, the operating element is a lever that is pivotably mounted on the casing and can be moved between its unlocked position and its locked position in only one direction of mounting of the cap on the lever, corresponding to a given orientation of the bundle of cables.

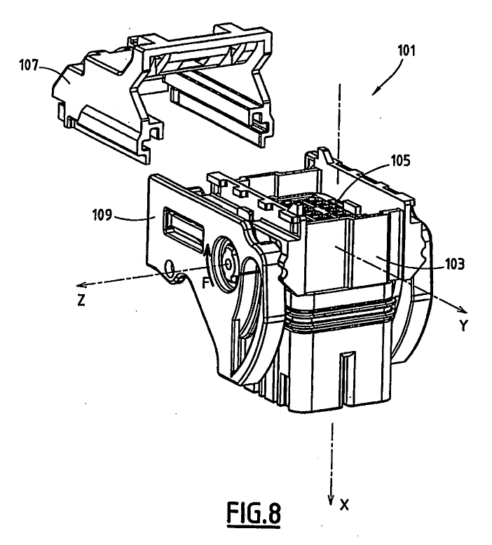

Depicted in FIG. 8 of the attached drawings is such a connector 101 of the prior art, comprising essentially an insulating casing 103, in which are formed cavities 105 for receiving contacts, a cap 107, and an operating lever 109, pivotably mounted on the casing 103. In this example, the cap 107 is intended for guiding the bundle of cables exiting the connector in the direction and sense represented by the Y axis, which is perpendicular to the coupling X axis of the connector 101 with its matching part.

In order to achieve the coupling of the connector 101 with its matching part (not depicted), the lever 109 has to be operated by rotating it approximately 90° around the Z axis in the direction F depicted in the figure.

Although the cap 107 may be mounted in a reversible manner on the casing 103, that is, symmetrically in relation to the median XZ plane of the connector and thus define two symmetrical orientations of the bundle of cables exiting the connector, it is understood that the lever 109 can function in only one of these orientations.

In the same way, the lever is intended to be capable of being mounted on the casing 103 in two symmetrical positions in relation to this same median XZ plane.

Thus, the direction of mounting of the lever 109 on the casing 103 determines the direction of mounting of the cap 107 on the casing, since the lever/casing subassembly can be appropriate for only one of the two orientations of the bundle.

The reversibility of mounting of the lever 109 on the casing 103, on the one hand, and of the casing 103 on the cap 107, on the other hand, allows a high degree of standardization to be achieved in manufacture. Nonetheless, as explained above, for two opposite orientations of the bundle of cables, the user must be supplied with two types of preassembled lever/casing subassemblies.

There ensue drawbacks in stock management and in supply organization, both on the part of the manufacturer as well as on that of the user.

The object of the invention is to remedy these drawbacks and, to this end, the subject of the invention is a connector of the above-mentioned type, in which the operating element is movably mounted on the cap.

Owing to this arrangement, the process of assembling the connector is clearly simplified and the molding of the casing can be achieved with much shorter cycle times.

According to other optional characteristics of the invention:

the operating element is movably mounted on the cap between an unlocked position of engagement and a locked position, corresponding to the position of complete coupling of the connector with its matching part, and the cap comprises means for releasing the detention of the operating element in its locked position;

the operating element is movably mounted on the cap between an unlocked position of engagement and a locked position, corresponding to the position of complete coupling of the connector with its matching part, and the cap comprises means for maintaining the operating element in its unlocked position;

the operating element is a lever that is rotatably mounted on the cap;

the lever is a U-shaped stirrup, each of the lateral branches of which has a groove that forms a cam track for a respective peg that is formed in one piece with the connector matching part;

the cap comprises two coaxial pivots, which project from opposite walls toward the exterior and define the axis of rotation of the lever;

the cap and the casing are provided with complementary means of fixation, such that the cap can be mounted on the casing in two different orientations, namely in two opposite senses in the same direction;

the cap, together with the casing, defines a cable exit that is oriented essentially orthogonally to the direction of coupling of the connector and its matching part;

the cap and the casing are provided with complementary sliding elements in such a way that the mounting of the cap onto the casing is achieved by engagement and relative sliding along a direction that is essentially orthogonal to the direction of coupling of the connector and its matching part; and

the complementary sliding elements are intended for permitting the mounting of the cap onto the casing in two opposite directions.

The invention also relates to a method for assembling a connector such as described above.

According to this method, the following is performed in succession:

the mounting of the operating element on the cap; and

the mounting and fixing in place of the cap, furnished with the operating element, on the pre-cabled casing.

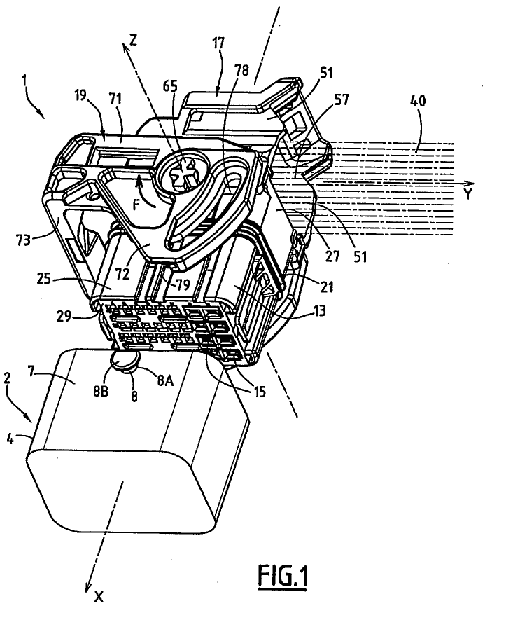

One particular embodiment of the invention will now be described in more detail with reference to FIGS. 1 to 7 of the attached drawings, in which:

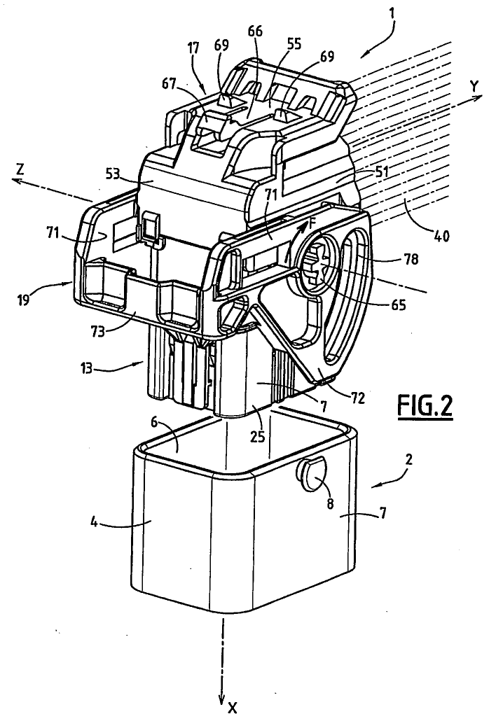

FIGS. 1 and 2 are perspective views, along two different directional axes, of a connector in accordance with the invention and of its connector matching part in an unlocked position prior to engagement;

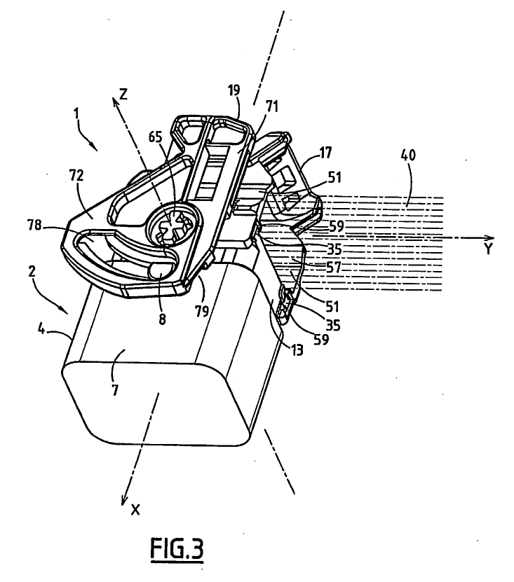

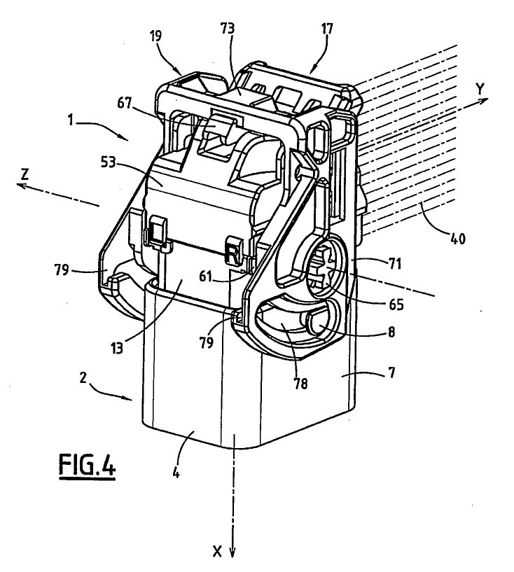

FIGS. 3 and 4 are views analogous to FIGS. 1 and 2, respectively, of the connector and its matching part in engaged position;

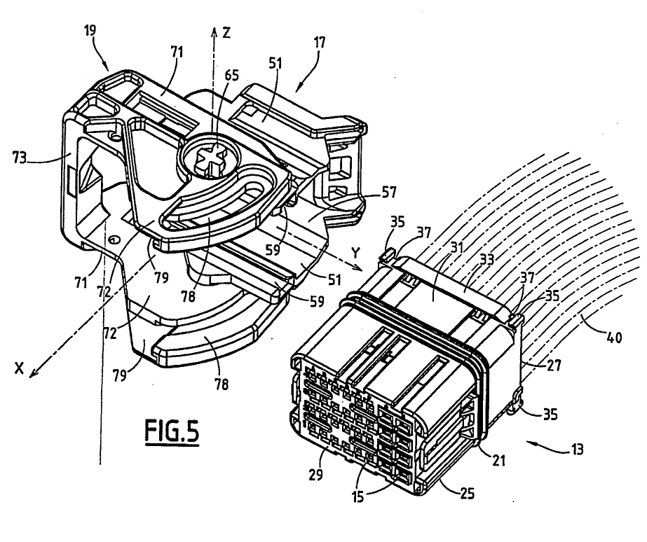

FIG. 5 is a perspective view of the connector of the preceding figures, showing the cap equipped with a lever that is separate from the casing;

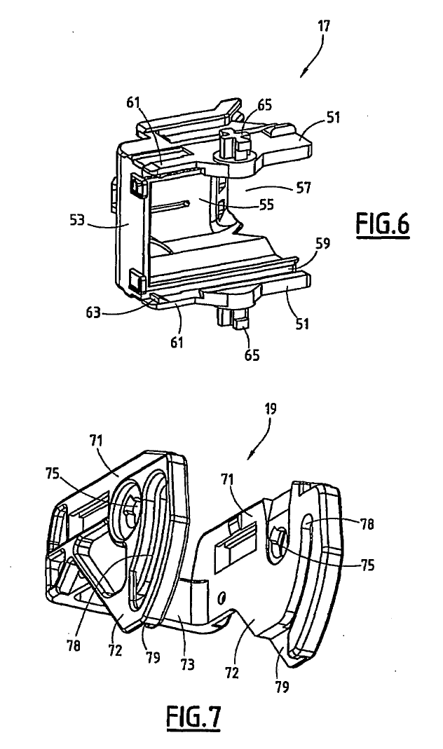

FIG. 6 is a perspective view of only the cap of the connector of the preceding figures, and

FIG. 7 is a perspective view of only the lever of the connector of the preceding figures.

Depicted in FIGS. 1 to 5 is a connector 1 in accordance with the invention of the type intended for connecting a bundle of cables to a motor vehicle computer system. The connector is depicted cabled.

Also depicted in FIGS. 1 to 4 is a part 2 of the computer system base forming the matching part for the connector 1.

Depicted in FIGS. 1 and 2 are the connector 1 and the base 2 in an unlocked position prior to coupling, whereas, in FIGS. 3 and 4, they are depicted in a coupled and locked position.

Introduced in FIGS. 1 to 5 for purposes of clarity in the following description is an X, Y, Z axis system, which defines the orientation of the connector 1 and in which:

the X axis represents the direction of coupling of the connector 1 on the base 2, oriented from the connector toward the base; and

the Y and Z axes are the orthogonal axes corresponding to the main directions of the geometry of the connector, the Z axis being the transverse axis.

In all of the following, the term “axial” is understood to mean directed along the X axis, which is assumed to be oriented from back to front.

As seen in FIGS. 1 to 4, the complementary base part 2 of the connector 1 comprises a shell 4 of general parallelepiped shape, which, in the interior, defines a chamber 6 for receiving the connector 1. Although not depicted in the figures, the male contacts (terminals or tabs) project axially into the interior of the chamber 6.

Two opposite lateral surfaces 7 of the shell 4 are each formed symmetrically with a peg 8, which projects transversally toward the exterior along the Z axis. Each peg 8 has a cylindrical base 8A and a broadened head 8B, which has a truncated disc shape and is coaxial with the base 8A.

As seen in FIGS. 1 to 5, the connector 1 comprises essentially an insulating casing 13 in which is formed a plurality of cavities 15 for receiving a contact, a cap 17, and an operating element 19 which allows the connector 1 and its matching part 2 to be coupled and decoupled.

The connector 1 also comprises a seal with interfacial lips 21, which is affixed to a peripheral section of the casing 13 and is intended for ensuring a peripheral tight sealing between the exterior walls of the casing 13 and the interior walls of the shell 4.

The casing 13 is formed essentially of a front block 25 of general parallelepiped shape complementary to the shell 4, and of a rear shell 27.

As seen in FIG. 5, the casing 13 has overall a general parallelepiped shape, the walls of the rear shell 27 being essentially an extension of the walls of the front block 25.

The front block 25 is perforated with axial passages which define the cavities 15, the latter opening toward the front on a coupling face 29 of the connector and toward the back into the space defined on the inside by the shell 27.

Preferably, the casing is made of one piece of molded plastic.

On each of the lateral surfaces 31, the rear shell 27 is formed with a rail 33, which extends along the length of the back edge, and, in the extension of the rail 33 at each of its ends, a stop block piece 35. Each stop block 35 is spaced from the respective end of the rail 33 so as to define a notch 37 that forms a safety catch.

Also depicted in FIGS. 1 to 5, in a schematic manner (dash-dot lines), is a bundle of cables 40, linking the individual cables to which are connected each of the electrical contacts engaged in the cavities of the casing 13.

The cap 17 will now be described in more detail with reference to FIGS. 1 to 6.

The cap 17 is constituted, in the example depicted, of a piece of molded plastic having two lateral walls 51, a transverse wall 53 joining the two lateral walls 51, and a rear wall 55.

On the side opposite the transverse wall 53, the cap 17 has an opening 57 which constitutes an exit for the bundle of cables 40 when the cap 17 is mounted on the casing 13. As seen in FIGS. 1 to 4, when the cap is mounted on the casing 13, the opening 57 is oriented along the Y axis in such a way that the cap 17 forms a guide for the cables in that direction.

The lateral walls 51 are formed, on their internal faces, with parallel slides 59. These slides 59 are adapted so as to receive in a sliding manner the rails 33 and the respective stop blocks 35 in such a way as to form together a sliding linkage that allows the sliding engagement of the cap 17 on the casing 13 in the Y direction.

Each of the lateral walls 51 is, moreover, provided, at the level of the slide 59, with a flexibly elastic tab 61 directed along the direction of the slide 59. The tab 61 is provided with a spur 63 that projects toward the interior of the cap 17 and is intended for fitting into one of the two notches 37 so as to retain, through elastic fitting, the cap 17 on the casing 13 in its functional position, depicted in FIGS. 1 to 4. In this functional position, the lateral walls 51 and the transverse wall 53 extend essentially in the extension of the corresponding walls of the casing.

The cap 17 is additionally provided with two coaxial pivots 65 that project toward the exterior, each from a respective lateral wall 51. In the example depicted, the pivots 65 have a transverse section that is cruciform and inscribed in a circle. The axis of pivot 65 is oriented orthogonally in relation to the general plane of the lateral walls 51 and to the direction of exit of the bundle, defined by the opening 57. The axis of the pivots 65 thus corresponds to the Z axis linked to the connector 1.

On its rear wall 55, the cap 17 is provided with a locking tab 66, furnished with a spur 67, which is flexible in its deflection and is intended for interactive elastic engagement with a corresponding part of the lever 19. Moreover, the wall 55 is furnished with studs 69, which form a stop piece for the lever 19.

The lever 19 will now be described in more detail with reference to FIGS. 1 to 5 and 7.

The lever 19 has the form of a U-shaped stirrup having two parallel lateral branches 71, each formed with a plate support 72, and a transverse branch 73 that links the two lateral branches 71.

The plate supports 72 are formed with coaxial orifices for engaging the pivots 65 of the cap 17 and, together with the latter, define the pivot linkage that allows the rotation of the lever 19 on the cap 17.

Moreover, the plate supports 72 are formed with inwardly curved parallel grooves 78, which are adapted for receiving the respective pegs of the shell 4, thereby defining the cam tracks for these pegs 8. The grooves 78 open on the edges of the plate support 72 via the flared entrances 79 for engagement of pegs 8.

It is evident that the lever 19, the cap 17, and the casing 13 have a general symmetry in relation to their median XY plane.

In particular, the cap 17 can be mounted and fixed in place onto the casing 13 in either of the two directions along Y. The mounting of the cap 17 onto the casing 13 is achieved by engaging the slides 59 on the rails 33 and the stop blocks 35, either from the left side, as shown in FIG. 5, or from the right side.

It is evident that, depending on the direction of mounting of the cap 17 onto the casing 13, the exit of the cables will be oriented either toward the right (as illustrated in FIGS. 1 to 5) or to the left.

In the unlocked position of mutual engagement of the connector 1 on the base 2, the lever 19 is maintained in an unlocked position of engagement owing to the releasable retaining means (not represented). The entrances 79 of the cam tracks are then facing the pegs 8.

In order to achieve the coupling of the connector 1 onto the base 2, the operator engages the front block 25 in the shell 4 and thus the pegs 8 in the corresponding entrances 79 of the cam tracks and operates the lever 19 so as to rotate it in the direction indicated by the arrow F.

The interaction of the pegs 8 and the cam tracks 78, when the lever 19 is rotated, produces the engagement of the connector 1 in the base 2 until the position of complete coupling represented in FIGS. 3 and 4 is achieved.

This position of complete coupling is obtained at the end of a rotational movement of the lever 19 along the entirety of its path. At the end of the lever's path, the edge of the transverse branch 73 of the latter engages on the locking tab 66, while, via an opposite face, the transverse branch 73 of the lever is locked by the stop studs 69. The lever is thus retained in its locked position, corresponding to the complete coupling of the connector 1 on the base 2, in one direction by the studs 69 and in the other direction by the spur 67.

The path of the lever 19 between its unlocked position and its locked position corresponds to a range of displacement of approximately 90°.

It is seen that, in contrast to the prior art illustrated by FIG. 8, the connector of the invention has an articulated lever on the cap and not on the casing.

Thus, the pivots are formed on the cap and not on the casing and this considerably simplifies the molding of the casing, without being detrimental to the manufacture of the cap, which remains a part with little complexity. In addition, this arrangement makes it possible to reduce the length of the rear shell of the casing along the X direction, which, in turn, makes it possible to clearly increase the speed of filling the mold of the casing and thus shorten the manufacturing cycle time of the casing.

The method for assembling the connector in accordance with the invention will now be described.

The essential parts of the connector described above, namely, the casing 13, the cap 17, and the lever 19, are manufactured separately of molded plastic.

The casing 13 is equipped with the seal 21 and possibly with other parts, which are not represented, such as a contact double-locking key, a seal of the “grommet” type generally placed in the rear shell 27, and a compression sleeve of the grommet, generally placed in and fitted in the shell 27 behind the grommet.

In an independent manner, the lever 19 is mounted on the cap 17 in its unlocked position, depicted particularly in FIG. 5.

In order to terminate the assembly of the connector 1, after cabling of the casing 13, the user engages the cap on the rails 33 and slides the cap 17 up to its locking position on the casing. The direction of assembly of the cap on the casing is chosen, in the assembly line chain, as a function of the orientation of the bundle exiting from the connector.

It is evident that only a single direction of mounting of the lever 19 on the cap 17 is possible.

Thus, the subassembly composed of the assembled lever and cap offers only one possible configuration, corresponding to a single subassembly reference.

The casings 13, equipped as indicated above, and the subassemblies constituted by the cap 17 and the lever 19 can be delivered independently of the orientation to be given to the bundles of cables exiting the connectors. Only the direction of mounting of the subassembly 17, 19 onto the casing 13 is linked to this orientation.

In light of the description that has just been given, it is understood that the user, as well as the manufacturer of the parts of the connector, need manage only one casing reference and only one cap/lever subassembly reference, regardless of the orientation (exit to the right or to the left) to be given to the bundle exiting the connector.

1. An electric connector comprising:
an insulating casing provided with cavities for receiving respective contacts connected to cables;
a cap that forms a guide for the cables and is arranged and fixed onto the casing; and
an operating element that is movably mounted on the assembly formed by the casing and the cap and is intended for interactive engagement with a complementary element disposed on the matching part for the connector in order to ensure the coupling or the decoupling of the connector and its matching part,
characterized in that the operating element is movably mounted on the cap.

2. The electric connector according to claim 1, further characterized in that the operating element is movably mounted on the cap between an unlocked position of engagement and a locked position corresponding to the position of complete coupling of the connector with its matching part, and in that the cap comprises means for releasing the retaining of the operating element in its locked position.

3. The electric connector according to claim 1, further characterized in that the operating element is movably mounted on the cap between an unlocked position of engagement and a locked position, corresponding to the position of complete coupling of the connector with its matching part, and in that the cap comprises means for maintaining the operating element in its unlocked position.

4. The electric connector according to claim 1, further characterized in that the operating element is a lever that is rotatably mounted on the cap.

5. The electric connector according to claim 4, further characterized in that the lever is a U-shaped stirrup, each of the lateral branches of which contains a groove that forms a cam track for a respective peg that is formed in one piece with the matching part for the connector.

6. The electric connector according to claim 5, further characterized in that the cap comprises two coaxial pivots, which project from opposite walls toward the exterior and define the axis (Z) of rotation of the lever.

7. The electric connector according to claim 1, further characterized in that the cap and the casing are provided with complementary means of fixation, such that the cap can be mounted onto the casing in two different orientations, namely in two opposite directions along a single directional axis (Y).

8. The electric connector according to claim 1, further characterized in that the cap, together with the casing, defines a cable exit that is oriented essentially orthogonally to the direction (X) of coupling of the connector and its matching part.

9. The electric connector according to claim 1, further characterized in that the cap and the casing are provided with complementary sliding elements in such a way that the mounting of the cap on the casing is achieved by engagement and relative sliding along a direction (Y) that is essentially orthogonal to the direction (X) of coupling of the connector and its matching part.

10. The electric connector according to claim 7, further characterized in that the cap and the casing are provided with complementary sliding elements in such a way that the mounting of the cap on the casing is achieved by engagement and relative sliding along a direction (Y) that is essentially orthogonal to the direction (X) of coupling of the connector and its matching part, and that the complementary sliding elements are intended for permitting the mounting of the cap onto the casing in two opposite directions.

11. A method for assembling a connector in accordance with claim 1, in which the following is performed in succession:
the mounting of the operating element onto the cap; and
the mounting and fixing in place of the cap, furnished with the operating element, on the pre-cabled casing.
